(19) United States
(12) Patent Application Publication
(10) Pub. No.: US 2008/0221968 A1
(43) Pub. Date: Sep. 11, 2008

(54) Method and system for interacting with users of portable devices

(76) Inventors: Tamara Gaffney, Belmont, CA (US); Kanishka Agarwal, San Francisco, CA (US)

Correspondence Address: HANLEY, FLIGHT & ZIMMERMAN, LLC, 150 S. WACKER DRIVE, SUITE 2100, CHICAGO, IL, 60606, US

(21) Appl. No.: 11/805,505

(22) Filed: May 22, 2007

Related U.S. Application Data
(60) Provisional application No. 60/905,680, filed on Mar. 7, 2007.

(51) Int. Cl. G06Q 30/00

(52) U.S. Cl. 705/10; 705/1; 705/14

(57) ABSTRACT

A method and system for interacting with users of portable devices is disclosed. Embodiments are directed to a mechanism for initiating interactions with users of a portable device in response to triggers detected in monitored data, where the monitored data may pertain to at least one of a time of day, a location of the portable device, a characteristic of the portable device, a characteristic of a wireless network over which the portable device communicates, and a user-initiated event associated with at least one of the portable device and an application running on the portable device. As such, the relevance of the timing of the interaction is increased. Further, the interactions may be tailored based upon the monitored data, thereby increasing the relevance of the content of the interaction. As such, embodiments provide means for intelligently interacting with users of portable devices.

### RELATED APPLICATIONS

The present application is related to and claims the benefit of U.S. Provisional Patent Application No. 60/905,680, filed Mar. 7, 2007, entitled “METHOD AND SYSTEM FOR INTERACTING WITH USERS OF PORTABLE DEVICES,” naming Tamara Gaffney and Kanishka Agarwal as inventors, assigned to the assignee of the present invention, and having attorney docket number TELE-P029.PRO. That application is incorporated herein by reference in its entirety and for all purposes.

### BACKGROUND OF THE INVENTION

An increasing number of mobile devices are being manufactured and used by consumers. For example, a large number of people in the United States own a mobile phone, portable computer (e.g., a PDA) and/or a portable media player. Additionally, the features offered by these devices continue to increase, thereby offering an increasing number of avenues for contacting users of these devices.

Despite the prevalence of mobile devices and the ability to use them to reach consumers, there exist few means to intelligently interact with the users of these devices. For example, a text message may be sent blindly to a user of a mobile phone. However, such messages are often irrelevant, blocked or otherwise ignored by the user. Similarly, a call may be placed to a user with a prerecorded message. However, such messages also fall upon deaf ears given their irrelevance and insignificant value to the user. Thus, businesses are left without viable means to deliver relevant communications (e.g., content, advertisements, etc.) to such users of portable devices.

### SUMMARY OF THE INVENTION

Accordingly, a need exists to interact with users of portable devices in a more intelligent manner. Further, a need exists to provide more relevant communications to a user of a portable device. Embodiments of the present invention provide novel solutions to these needs and others as described below.

Embodiments of the present invention are directed to a method and system for interacting with users of portable devices. More specifically, embodiments are directed to a mechanism for initiating interactions with users of a portable device in response to triggers (e.g., a data attribute, data attribute value, etc.) detected in monitored data (e.g., monitored using hardware and/or software on the portable device, monitored by a system external to the portable device, etc.), where the monitored data may pertain to at least one of a time of day, a location of the portable device, a characteristic of the portable device, a characteristic of a wireless network over which the portable device communicates, and a user-initiated event associated with at least one of the portable device and an application running on the portable device. As such, the relevance of the timing of the interaction is increased. Further, the interactions may be tailored based upon the monitored data, thereby increasing the relevance of the content of the interaction. As such, embodiments provide means for intelligently interacting with users of portable devices.

In one embodiment, a computer-implemented method of interacting with users of portable devices includes monitoring data on a portable device. A data trigger within the monitored data is detected using at least one component of the portable device. An interaction is initiated with a user of the portable device in response to the detecting of the data trigger, wherein the interaction is associated with at least one attribute of the monitored data. The method may also include accessing additional data associated with the at least one attribute of the monitored data. The additional data may then be used to interact with the user.

In another embodiment, a computer-implemented method of interacting with users of portable devices includes monitoring data on a portable device. A plurality of data triggers within the monitored data are detected using at least one component of the portable device. An interaction is initiated with a user of the portable device in response to the detecting of the plurality of data triggers, wherein the interaction is associated with at least one attribute of the monitored data. The method may also include accessing additional data associated with the at least one attribute of the monitored data. The additional data may then be used to interact with the user.

In yet another embodiment, a system for interacting with users includes a first component for monitoring data on a portable device and for detecting a data trigger within the monitored data. A second component is coupled to the first component and for initiating an interaction with a user of the portable device in response to the detecting of the data trigger by the first component, wherein the interaction is associated with at least one attribute of the monitored data. The system may also include a processor coupled to the first and second components, the processor for receiving a trigger signal from the first component and generating an output signal based upon the received trigger signal. The output signal may be fed to the second component for initiating a corresponding interaction with the user.

### BRIEF DESCRIPTION OF THE DRAWINGS

The present invention is illustrated by way of example, and not by way of limitation, in the figures of the accompanying drawings and in which like reference numerals refer to similar elements.

FIG. 1 shows an exemplary system for interacting with a user of a portable device in accordance with one embodiment of the present invention.

FIG. 2 shows a table of exemplary data triggers related to location in accordance with one embodiment of the present invention.

FIG. 3 shows a table of exemplary data triggers related to device characteristics in accordance with one embodiment of the present invention.

FIG. 4 shows a table of exemplary data triggers related to network characteristics in accordance with one embodiment of the present invention.

FIG. 5 shows a table of exemplary data triggers related to user-initiated events in accordance with one embodiment of the present invention.

FIG. 6 shows an exemplary process for interacting with a user of a portable device in response to a data trigger in accordance with one embodiment of the present invention.

FIG. 7 shows an exemplary process for interacting with a user of a portable device in response to multiple data triggers in accordance with one embodiment of the present invention.

FIG. 8 shows an exemplary computer system upon which embodiments of the present invention may be implemented.

### DETAILED DESCRIPTION OF THE INVENTION

Reference will now be made in detail to embodiments of the present invention, examples of which are illustrated in the accompanying drawings. While the present invention will be discussed in conjunction with the following embodiments, it will be understood that they are not intended to limit the present invention to these embodiments alone. On the contrary, the present invention is intended to cover alternatives, modifications, and equivalents which may be included with the spirit and scope of the present invention as defined by the appended claims. Furthermore, in the following detailed description of the present invention, numerous specific details are set forth in order to provide a thorough understanding of the present invention. However, embodiments of the present invention may be practiced without these specific details. In other instances, well-known methods, procedures, components, and circuits have not been described in detail so as not to unnecessarily obscure aspects of the present invention.

### Notation and Nomenclature

Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing the terms such as “accepting,” “accessing,” “adding,” “analyzing,” “assembling,” “assigning,” “calculating,” “capturing,” “combining,” “comparing,” “collecting,” “creating,” “defining,” “depicting,” “detecting,” “determining,” “displaying,” “establishing,” “executing,” “generating,” “grouping,” “identifying,” “initiating,” “interacting,” “modifying,” “monitoring,” “moving,” “outputting,” “performing,” “placing,” “presenting,” “processing,” “programming,” “querying,” “removing,” “repeating,” “sampling,” “sorting,” “storing,” “using,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

### Embodiments of the Invention

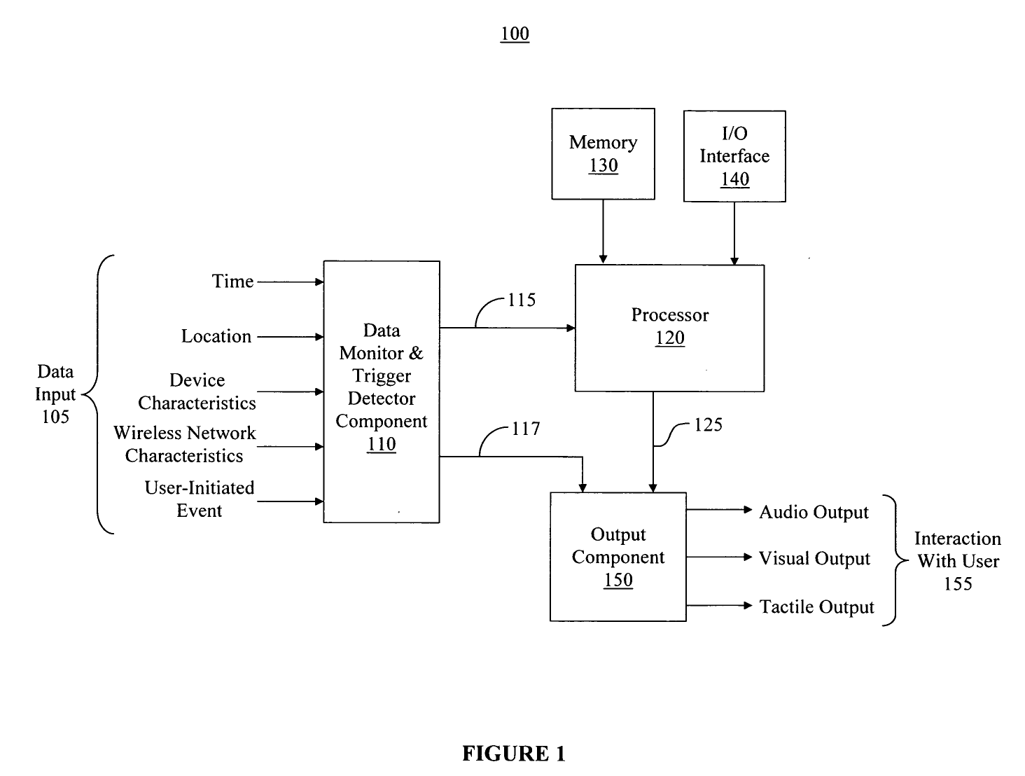

FIG. 1 shows exemplary system 100 for interacting with a user of a portable device in accordance with one embodiment of the present invention. As shown in FIG. 1, data monitor and trigger detector component 110 is operable to monitor and detect triggers in data 105. Data 105 may comprise one or more data types (e.g., time, location, device characteristics, wireless network characteristics, user-initiated events, etc.), where each data type may be received by component 110 separately (e.g., on separate buses) or combined with one or more other data types (e.g., combined into at least one bus comprising multiple data types). In one embodiment, data monitoring may be performed as discussed in U.S. Pat. Nos. 6,745,011 and 6,754,470, the disclosure of which are hereby incorporated by reference.

In response to detecting a trigger associated with data 105, component 110 may generate trigger signal 115 and/or trigger signal 117. Processor 120 may receive trigger signal 115 and use it to generate output signal 125, where a portion of the data comprising output signal 125 may be accessed from memory 130 and/or input/output interface 150 (e.g., for coupling to the internet, an external system, external database, etc.). Alternatively, output signal 117 may be output from component 110 and fed directly to output component 150. Upon receiving output signal 115 and/or output signal 117, output component 150 may generate audio output, visual output and/or tactile output for interacting with a user of a portable device.

Component 110, processor 120 and component 150 may be implemented in a single portable device (e.g., a mobile telephone, portable gaming device, portable media device, portable digital assistant (PDA), hand-held computer system, etc.). Alternatively, one or more of component 110, processor 120 and component 150 may be implemented within an external device. For example, where component 110 and processor 120 are implemented within a portable device, output component 150 may be an external output component which may be coupled (e.g., hardwired, detachably coupled, etc.) to the portable device. As an alternative example, data trigger detection and/or processing may be performed by an external device, where either the trigger signal or the output signal is fed to the portable device for output therefrom. Such an embodiment may be useful when data trigger detection, processing capabilities or other capabilities (e.g., power supply capacity, etc.) are limited in the portable device.

As shown in FIG. 1, component 110 may monitor one or more types of data and detect at least one data trigger therein. A data trigger may comprise a specific level or a change in a level of a signal (e.g., above or below a given threshold), where the signal may be analog and/or digital. Alternatively, a trigger may be indicated by a plurality of signal changes (e.g., occurring in parallel, in series, or a combination of both). Additionally, the data trigger may be represented by a detected data type (e.g., location), a data attribute (e.g., city name) and/or a data attribute value (e.g., San Francisco). Alternatively, the data trigger may be represented by a lack of a signal (e.g., ground, a bit value of zero, etc.), data type, data attribute and/or data attribute value. For example, when monitoring a location data signal, detection of an absence of a location (e.g., when location information is not available, etc.) may represent a data trigger.

Additionally, component 110 may detect multiple data triggers relating to a single data type (e.g., multiple device characteristics). Alternatively, the multiple data triggers detected by component 110 may correspond to multiple data types (e.g., a device characteristic and a network characteristic). Further, the multiple data triggers may occur in series, in parallel, or a combination of both.

Component 110 may comprise logic sufficient to control assertion of a trigger signal (e.g., 115, 117, etc.) in response to detection of one or more detected data triggers. For example, component 110 may be programmed to assert a trigger signal if “time=noon,” where “noon” represents a data trigger. Alternatively, component 110 may assert a trigger signal if “time=noon” and “location=Peet's Coffee,” where both “noon” and “Peet's Coffee” represent data triggers. Further, the logic of component 110 may be programmed to assert trigger signal upon a recognized sequence of data triggers. For example, a detected sequence of events comprising a user opening a browser of a mobile device (e.g., representing a user-initiated event data trigger), then approaching a Peet's Coffee store (e.g., representing a location data trigger), and finally a time of noon being detected, may cause component 110 to assert a trigger signal (e.g., 115, 117, etc.).

It should be appreciated that the logic of component 110 may be preprogrammed (e.g., at the factory) and/or subsequently configured (e.g., through flash reprogramming, etc.). Alternatively, the logic of component 110 may be configured on-the-fly (e.g., in response to a given sequence of detected triggers, etc.).

As shown in FIG. 1, data 105 may comprise a plurality of different types of data for monitoring by component 110, and from which component 110 may detect data triggers. For example, data 105 may comprise time data. Time data may indicate a specific time of day. Alternatively, it may indicate a duration of time. As such, time data triggers may be used alone or in combination with other data triggers (e.g., a user-initiated event performed at a specific time of day, a device characteristic detected for a given duration of time, etc.).

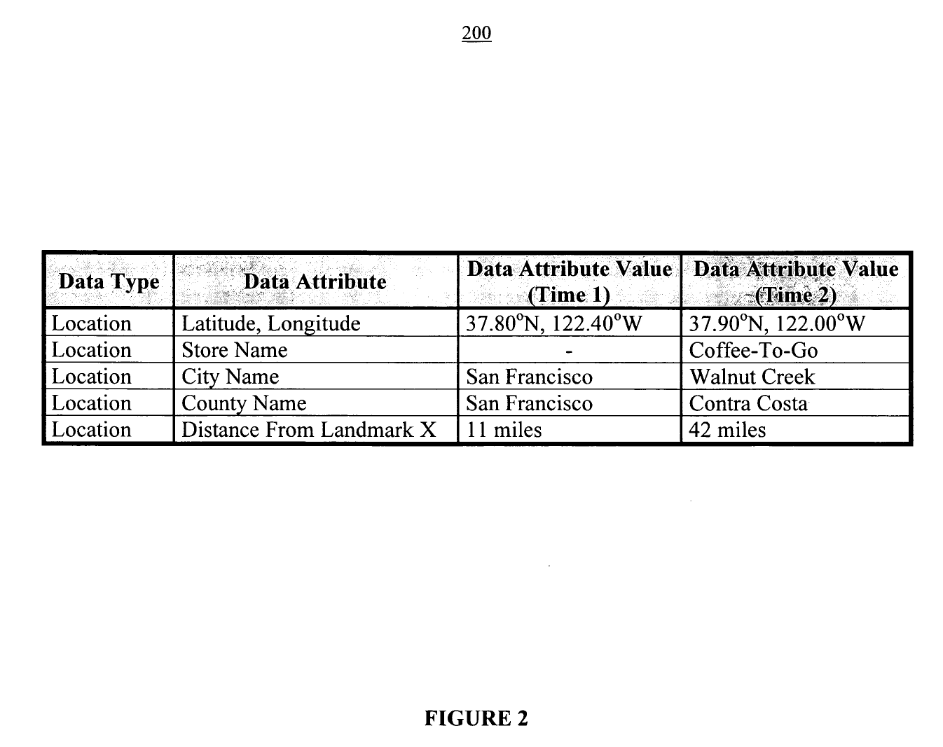

FIG. 2 shows table 200 of exemplary data triggers related to location in accordance with one embodiment of the present invention. As shown in FIG. 2, a data trigger relating to location may comprise an indication of the data type itself (e.g., location), one or more data attributes related to location (e.g., latitude/longitude, store name, city name, county name, distance from a given landmark, etc.) or a data attribute value (e.g., as listed in table 200). The location may relate to that of a portable device (e.g., implementing one or more components of system 100, etc.), a user of a portable device, etc. Additionally, table 200 illustrates how a null data attribute value (e.g., store name at time 1) may be used as a data trigger for detection (e.g., by component 110).

Further, time data may be combined with location data (e.g., comprising multiple data triggers as discussed above). For example, assuming the values in table 200 represent trigging events, then a trigger signal (e.g., 115, 117, etc.) may be asserted upon detection of a time trigger equal to “time 1” and a location trigger equal to “San Francisco.” However, if a trigger is to be set at a time trigger equal to “time 2” and a location trigger equal to “San Francisco,” then a trigger signal may not be asserted given the values in table 200 since the city name is “Walnut Creek” at time 2. Additionally, in one embodiment, the use of time triggers in conjunction with other types of triggers provides the ability to assert triggers (e.g., with trigger signal 115, trigger signal 117, etc.) in response to a change in a data attribute value over time, maintaining of a data attribute value for a given period of time, etc.

Although a specific number of data attributes and data attribute values are depicted in FIG. 2, it should be appreciated that a larger or smaller number may be used in other embodiments. Additionally, although data attributes are listed for only two times, it should be appreciated that a larger or smaller number of times may be used in other embodiments. Also, it should be appreciated that the data attribute values may be listed in alternative fashions (e.g., as delta values indicating a change in the data attribute value, etc.). Further, it should be appreciated that location data triggers may be used in conjunction with one or more data triggers associated with other data types (e.g., device characteristics, network characteristics, user-initiated events, etc.) in other embodiments.

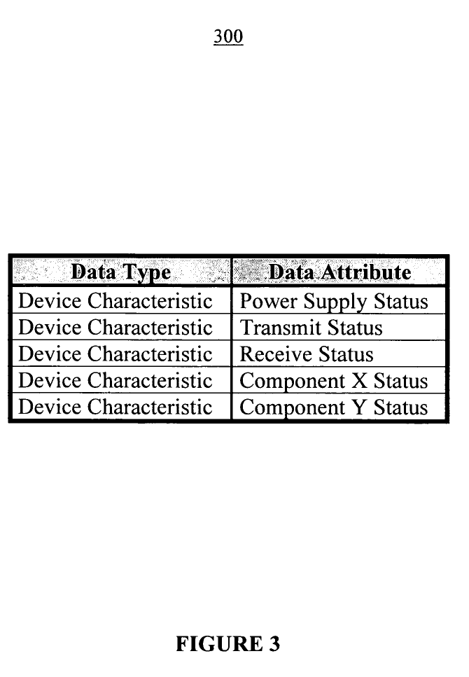

FIG. 3 shows table 300 of exemplary data triggers related to device characteristics in accordance with one embodiment of the present invention. As shown in FIG. 3, data attributes related to device characteristics (e.g., of a portable device implementing one or more components of system 100) may comprise a power supply status (e.g., power level, power supply operating voltage, whether the device is charging, whether a power supply of the device has failed, etc.), a transmit status (e.g., transmit power, whether the device is currently transmitting, a current transmit rate, etc.), a receive status (e.g., receive power, whether the device is currently receiving, a current receive rate, etc.) and/or a status related to another component (e.g., “component X,” “component Y,” etc.) of the device (e.g., whether an error is detected related to that component, a parameter or operating characteristic of the device, etc.).

Although exemplary data attribute values are not depicted in FIG. 3 as previously depicted in FIG. 2, it should be appreciated that each data attribute may have corresponding data attribute values. As such, data triggers may comprise a data type, a data attribute or a data attribute value as described above. When a trigger signal assertion is based upon multiple triggers, it should be appreciated that the detected data triggers may comprise one or more data type triggers, one or more data attribute triggers, one or more data attribute value triggers, or any combination thereof.

Although a specific number of data attributes are depicted in FIG. 3, it should be appreciated that a larger or smaller number may be used in other embodiments. Additionally, it should be appreciated that device characteristic data triggers may be used in conjunction with one or more data triggers associated with other data types (e.g., time, location, network characteristics, user-initiated events, etc.) in other embodiments.

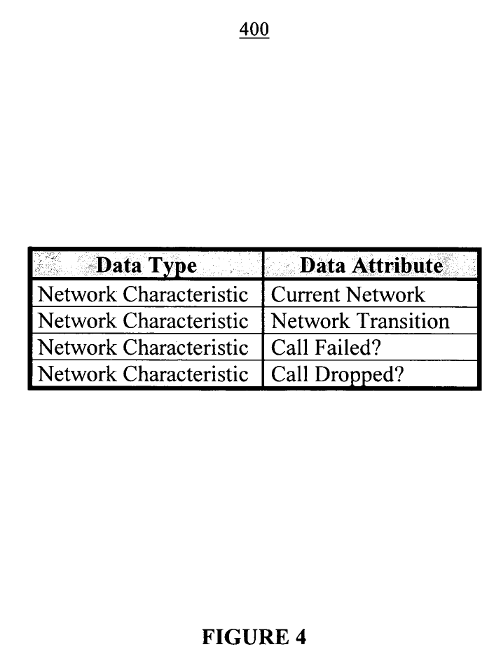

FIG. 4 shows table 400 of exemplary data triggers related to network characteristics in accordance with one embodiment of the present invention. As shown in FIG. 4, data attributes related to network characteristics (e.g., of a network accessible by a portable device implementing one or more components of system 100) may comprise an identification of a current network (e.g., that which the device is connected to, that which may be connected to by the device, etc.), a network transition (e.g., a switch from a given network, a switch to a given network, etc.), whether a call has failed, whether a call is dropped, etc.

Although exemplary data attribute values are not depicted in FIG. 4 as previously depicted in FIG. 2, it should be appreciated that each data attribute may have corresponding data attribute values. As such, data triggers may comprise a data type, a data attribute or a data attribute value as described above. When a trigger signal assertion is based upon multiple triggers, it should be appreciated that the detected data triggers may comprise one or more data type triggers, one or more data attribute triggers, one or more data attribute value triggers, or any combination thereof.

Although a specific number of data attributes are depicted in FIG. 4, it should be appreciated that a larger or smaller number may be used in other embodiments. Additionally, it should be appreciated that network characteristic data triggers may be used in conjunction with one or more data triggers associated with other data types (e.g., time, location, device characteristics, user-initiated events, etc.) in other embodiments.

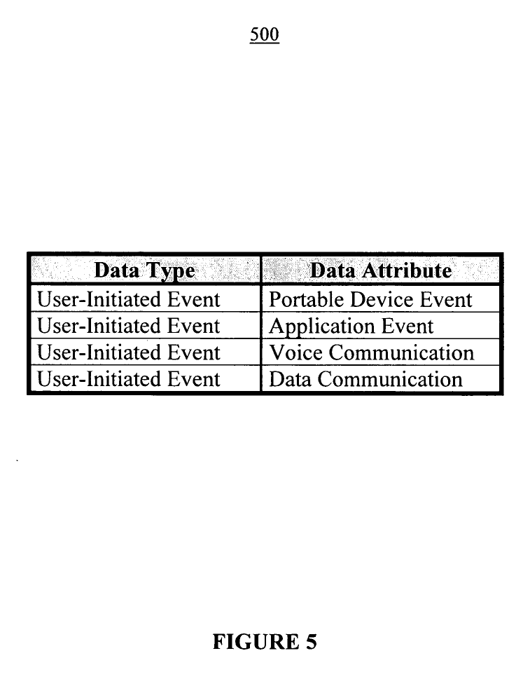

FIG. 5 shows table 500 of exemplary data triggers related to user-initiated events in accordance with one embodiment of the present invention. As shown in FIG. 5, data attributes related to user-initiated events may comprise any activity on a portable device by a user. For example, such data attributes may comprise a portable device event (e.g., turning the device on and/or off, pressing a given button, closing the device, etc.), an application event (e.g., opening and/or closing an application, interacting with a game, pulling up a given website in a browser, changing a mobile TV channel, downloading a data object, etc.), a voice communication (e.g., initiating a call, ending a call, placing someone on hold, initiating/ending a conference call, placing a call to a certain party, placing a call to a certain geographical area, etc.) and/or a data communication (e.g., sending a data message, replying to a data message, sending a data message to a certain party, etc.).

Although exemplary data attribute values are not depicted in FIG. 5 as previously depicted in FIG. 2, it should be appreciated that each data attribute may have corresponding data attribute values. As such, data triggers may comprise a data type, a data attribute or a data attribute value as described above. When a trigger signal assertion is based upon multiple triggers, it should be appreciated that the detected data triggers may comprise one or more data type triggers, one or more data attribute triggers, one or more data attribute value triggers, or any combination thereof.

Although a specific number of data attributes are depicted in FIG. 5, it should be appreciated that a larger or smaller number may be used in other embodiments. Additionally, it should be appreciated that user-initiated event data triggers may be used in conjunction with one or more data triggers associated with other data types (e.g., time, location, device characteristics, network characteristics, etc.) in other embodiments.

Turning back to FIG. 1, trigger signal 115 may comprise a generic trigger identification signal (e.g., without identification of a data type, data attribute, data attribute value, etc.). In one embodiment, processor 120 may essentially pass the generic data trigger identification signal onto component 150 for interaction with a user (e.g., 155).

Alternatively, trigger signal 115 may indicate one or more of a data type, data attribute and a data attribute value, where the signal may be conveyed over one or more buses. Processor 120 may access at least a portion of the information conveyed in the data trigger signal (e.g., 115) for use in generating output signal 125 such that an appropriate (e.g., in accordance with at least one attribute of the monitored data, attribute value of the monitored data, etc.) interaction with a user (e.g., 155) is initiated. Output signal 125 may comprise data accessed via memory 130, I/O interface 140 and/or other components of system 100, where the data to be accessed (e.g., by processor 120) may be determined based upon the monitored data and/or a detected data trigger. The determination of which data to access may be made using a look-up table (e.g., stored in a register or memory of the processor, stored in a memory external to the processor, etc.) indexing one or more data triggers and/or data trigger combinations with data to be downloaded. And in other embodiments, processor 120 may use other means to determine the appropriate data for download based on the detected trigger or detected data triggers.

For example, if trigger signal 115 indicates that a user is near a Peet's Coffee store (e.g., a location data attribute value equal to “Peet's Coffee”), then processor 120 may determine that an appropriate interaction with the user of the portable device is to send the user a coupon for Peet's Coffee. Data used to generate the coupon and any associated interaction (e.g., sound in the form of a jingle or an alert, tactile stimulation to get the user's attention, etc.) may be accessed using memory 130 and/or I/O interface 140, where the accessed data may be used to generate output signal 125 fed to component 150. As a further example, if the trigger signal 115 indicates that a user has just switched from Yahoo's website to that of Google, a survey (e.g., data for which may be downloaded via memory 140, I/O interface 150, etc.) may be presented to the user to inquire about the user's experience on Yahoo's site, why the user switched to using Google as a search engine, etc. As such, interaction 155 (e.g., with a user of a portable device) may therefore be made relevant with respect to timing (e.g., given that the interaction is in response to the detected data trigger or detected data triggers) and with respect to content (e.g., since it is tailored based upon the monitored data).

Interaction 155 may comprise an audio output, a visual output, a tactile output, or any combination thereof. An audio output (e.g., where component 150 comprises a speaker or other audio generating device) may comprise a verbal communication, music, an alert, etc. A visual output (e.g., where component 150 comprises a display, lights, or other light generating device) may comprise a visual communication (e.g., a message, etc.), still content (e.g., a picture, text, etc.), moving content (e.g., a video), a visual alert, etc. A tactile output (e.g., where component 150 comprises a vibrator or other device capable of generating tactile sensations) may comprise a tactile communication (e.g., a message using vibrations, etc.), a tactile alert, etc.

Interaction 155 may be generated by component 150 in response to trigger signal 115 and/or trigger signal 117. Trigger signal 117 may be fed directly from component 110 to output component 150 (e.g., bypassing processor 120) for initiating an interaction with a user. Similar to signal 115, signal 117 may indicate one or more of a data type, data attribute and a data attribute value, where the signal may be conveyed over one or more buses. The data for generating interaction 155 may be provided by component 110, or alternatively, by component 150. As such, trigger signal 117 may initiate an audio output, a visual output, a tactile output, or a combination thereof.

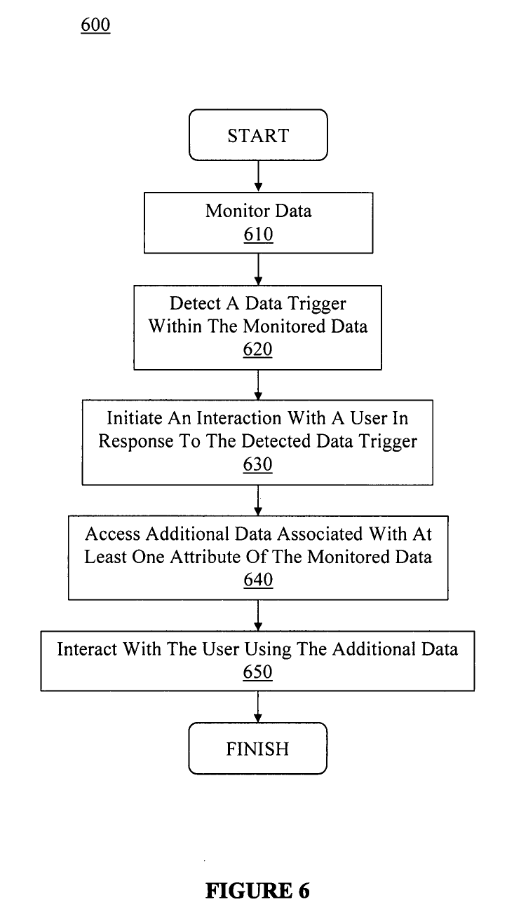

FIG. 6 shows exemplary process 600 for interacting with a user of a portable device in response to a data trigger in accordance with one embodiment of the present invention. As shown in FIG. 6, step 610 involves monitoring data. The data (e.g., 105 of FIG. 1) may comprise one or more types of data (e.g., time, location, device characteristics, wireless network characteristics, user-initiated events, etc.). Additionally, the data may be monitored by a portable device (e.g., that which the data pertains to), or alternatively, by one or more external systems and/or devices.

Step 620 involves detecting a data trigger within the monitored data. A data trigger may comprise a specific level or a change in a level of a signal (e.g., above or below a given threshold), where the signal may be analog and/or digital. Alternatively, a trigger may be indicated by a plurality of signal changes (e.g., occurring in parallel, in series or a combination of both). Additionally, the data trigger may be represented by a detected data type (e.g., location), a data attribute (e.g., city name) and/or a data attribute value (e.g., San Francisco). Alternatively, the data trigger may be represented by a lack of a signal (e.g., ground, a bit value of zero, etc.), data type, data attribute or data attribute value.

As shown in FIG. 6, step 630 involves initiating an interaction with a user in response to the detected data trigger. The interaction may occur immediately after or contemporaneously with the detected data trigger, thereby increasing the relevance to the user with respect to timing. Alternatively, the interaction may be initiated at some time (e.g., predetermined, determined on-the-fly, etc.) after the data trigger is detected. Additionally, the interaction may relate to the monitored data and/or the detected data triggers (e.g., as described above with respect to the preceding figures), thereby tailoring the content of the interaction to the monitored data and increasing the relevance of the content of the interaction to the user.

Step 640 involves accessing additional data associated with at least one attribute of the monitored data. The additional data may be accessed from a memory (e.g., 130 of FIG. 1) and/or an input/output interface (e.g., 140 of FIG. 1) for coupling to the internet, an external system, an external device, etc. For example, if a data trigger comprises an indication that the portable device and/or user of the portable device are in proximity to a Peet's Coffee store, then the additional data accessed in step 640 may comprise a coupon for use in the store, directions to the store, etc. Further, the accessed data may be at least one of audio, visual and tactile data. As such, the interaction is further tailored to attributes (e.g., location) and/or attribute values (e.g., location equals “Peet's Coffee”) of the monitored data.

After accessing the additional data, an interaction using the additional data may be carried out with the user in step 650. The interaction (e.g., 155 of FIG. 1) may comprise at least one of an audio, visual and a tactile interaction. Additionally, in one embodiment, the interaction may be performed by an output component (e.g. 150 of FIG. 1) of the portable device.

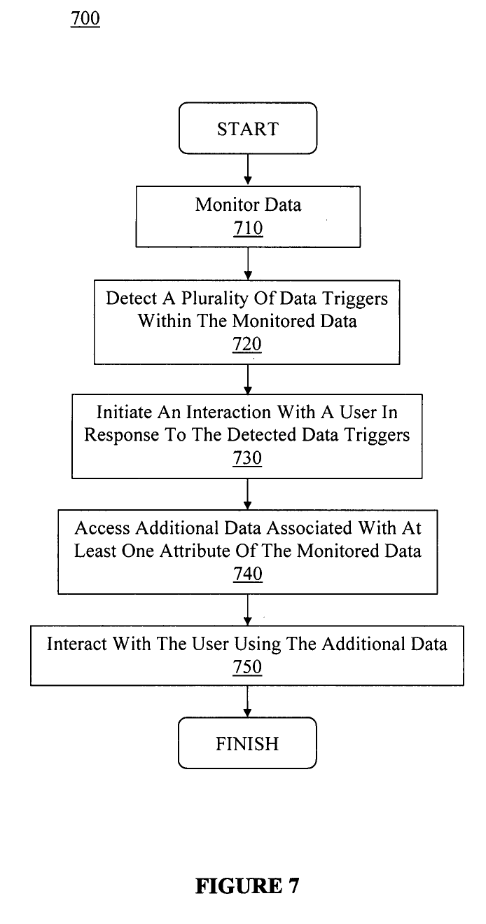

FIG. 7 shows exemplary process 700 for interacting with a user of a portable device in response to multiple data triggers in accordance with one embodiment of the present invention. As shown in FIG. 7, step 710 involves monitoring data. The data (e.g., 105 of FIG. 1) may comprise one or more types of data (e.g., time, location, device characteristics, wireless network characteristics, user-initiated events, etc.). Additionally, the data may be monitored by a portable device (e.g., that which the data pertains to), or alternatively, by one or more external systems and/or devices.

Step 720 involves detecting a plurality of data triggers within the monitored data. Each data trigger may be detected analogously to the data trigger detection described above with respect to step 620 of FIG. 6. The plurality of data triggers may component 110 may relate to a single data type (e.g., multiple device characteristics). Alternatively, the plurality of data triggers may correspond to multiple data types (e.g., a device characteristic and a network characteristic). Further, the detected data triggers may occur in series, in parallel, or a combination of both.

As shown in FIG. 7, step 730 involves initiating an interaction with a user in response to the detected data triggers. The interaction may occur immediately after or contemporaneously with the detected data triggers, thereby increasing the relevance to the user with respect to timing. Alternatively, the interaction may be initiated at some time (e.g., predetermined, determined on-the-fly, etc.) after the data triggers are detected. Additionally, the interaction may relate to the monitored data and/or the detected data triggers (e.g., as described above with respect to FIG. 1 through FIG. 5), thereby tailoring the content of the interaction to the monitored data and increasing the relevance of the content of the interaction to the user.

Step 740 involves accessing additional data associated with at least one attribute of the monitored data. The additional data may be accessed analogously to that described above in step 640 of FIG. 6.

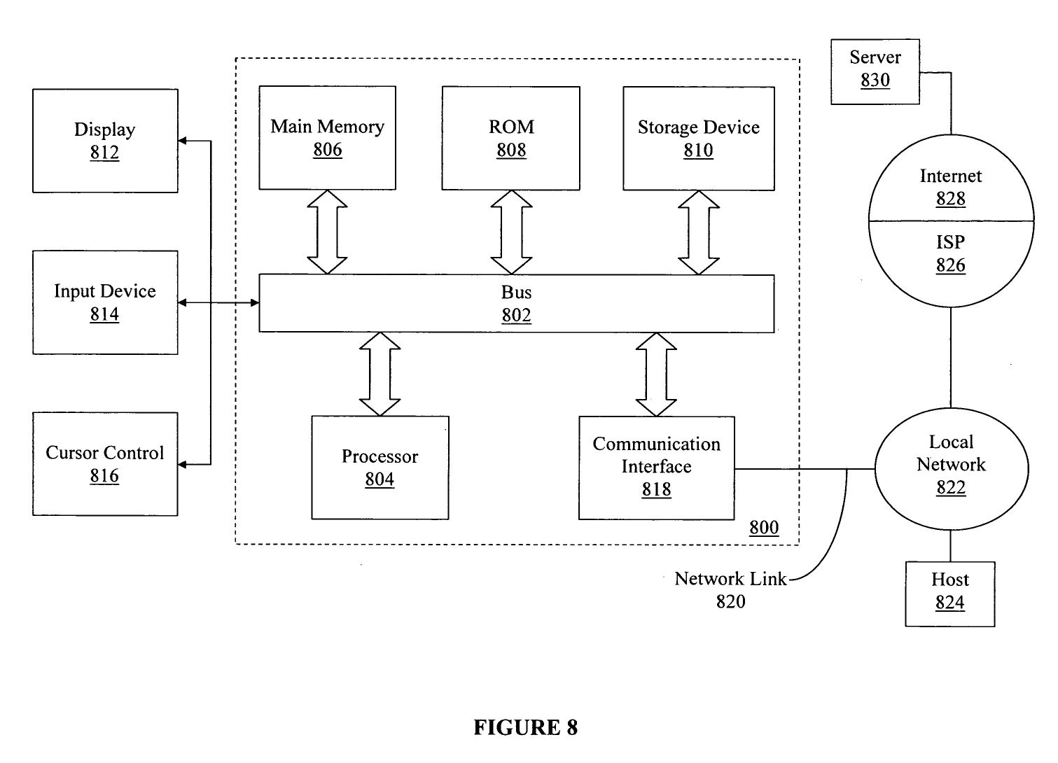

After accessing the additional data, an interaction using the additional data may be carried out with the user in step 750. The interaction may be analogous to that of step 650 of FIG. 6. Computer System Platform FIG. 8 shows exemplary computer system 800 upon which embodiments of the present invention may be implemented. With reference to FIG. 8, portions of the present invention are comprised of computer-readable and computer-executable instructions that reside, for example, in computer system 800 which may be used as a part of a general purpose computer network (not shown). It is appreciated that computer system 800 of FIG. 8 is merely exemplary. As such, the present invention can operate within a number of different computer systems including general-purpose computer systems, embedded computer systems, laptop computer systems, hand-held computer systems, portable computer systems (e.g., portable devices), and stand-alone computer systems.

In the present embodiment, computer system 800 includes an address/data bus 802 for conveying digital information between the various components, a central processor unit (CPU) 804 coupled to bus 802 for processing the digital information and instructions, a volatile main memory 806 coupled to bus 802 comprised of volatile random access memory (RAM) for storing the digital information and instructions, and a non-volatile read only memory (ROM) 808 coupled to bus 802 for storing information and instructions of a more permanent nature. In addition, computer system 800 may also include a data storage device 810 (e.g., a magnetic, optical, floppy, tape, or other drive) coupled to bus 802 for storing larger amounts of data. It should be noted that the software program for performing the method of interacting with users of portable devices of the present invention may be stored in main memory 806, ROM 808, storage device 810, registers within CPU 804 (not shown), and/or in an external storage device (not shown).

As shown in FIG. 8, computer system 800 may be coupled via bus 802 to an optional display device 812 (e.g., a CRT monitor, LCD monitor, etc.) for displaying information received from computer system 800. An optional input device 814 (e.g., an alphanumeric keyboard) may also be coupled to computer system 800 via bus 802 for communicating information and command selections

to CPU 804. Cursor control device 816 (e.g., a mouse, trackball, light pen, etc.) may also be coupled to computer system 800 via bus 802 for communicating direction information and command selections to CPU 804 and for controlling cursor movement (e.g., on display 812). Additionally, computer system 800 can include a mechanism for emitting an audible signal (not shown).

Computer system 800 may also include a communication interface 818 coupled to bus 802. Communication interface 818 provides a two-way data communication coupling to local network 822 via network link 820. For example, communication interface 818 may be an integrated services digital network (ISDN) device or modem to provide a data communication connection to a corresponding type of telephone line. As another example, communication interface 818 may be a local area network (LAN) device to provide a data communication connection to a compatible LAN. And as yet another example, network link 820 may comprise a wireless connection between communication interface 818 and local network 822. Regardless of the implementation utilized, communication interface 818 may send and receive electrical, electromagnetic, and/or optical signals that carry digital data streams representing various types of information.

As shown in FIG. 8, network link 820 may provide data communication through one or more networks to other data devices. For example, network link 820 may provide a connection through local network 822 to a host computer 824 or to data equipment operated by internet service provider (ISP) 826. ISP 826 in turn provides data communication services through the worldwide packet data communication network, now commonly referred to as the “Internet” 828. Local network 822 and Internet 828 may use electrical, electromagnetic, and/or optical signals to convey digital data streams. The signals through the various networks and network link 820, which carry digital data to and from computer system 800, are exemplary forms of carrier waves transporting information.

Accordingly, computer system 800 can send and receive messages through networks(s), network link 820, and communication interface 818. For example, server 830 may transmit a requested code for an application program through Internet 828, ISP 826, local network 822, and communication interface 818. The received code may be executed by CPU 804 upon receipt, and/or be stored in one of the coupled memory devices (e.g., storage device 810, ROM 808, RAM 806, etc.) for later execution.

In the foregoing specification, embodiments of the invention have been described with reference to numerous specific details that may vary from implementation to implementation. Thus, the sole and exclusive indicator of what is, and is intended by the applicant to be, the invention is the set of claims that issue from this application, in the specific form in which such claims issue, including any subsequent correction. Hence, no limitation, element, property, feature, advantage, or attribute that is not expressly recited in a claim should limit the scope of such claim in any way. Accordingly, the specification and drawings are to be regarded in an illustrative rather than a restrictive sense.

What is claimed is:

1. A computer-implemented method of interacting with users of portable devices, said method comprising:
monitoring data on a portable device;
detecting a data trigger within said monitored data using at least one component of said portable device; and
initiating an interaction with a user of said portable device in response to said detecting of said data trigger, wherein said interaction is associated with at least one attribute of said monitored data.

2. The method of claim 1, wherein said portable device is selected from a group consisting of a mobile telephone, a gaming device, and a media device.

3. The method of claim 1, wherein said data trigger is selected from a group consisting of a time of day and a location of said portable device.

4. The method of claim 1, wherein said data trigger comprises a characteristic of said portable device.

5. The method of claim 4, wherein said characteristic of said portable device is selected from a group consisting of a power supply status, a transmit status, a receive status, and a status of a component of said portable device.

6. The method of claim 1, wherein said data trigger comprises a characteristic of a wireless network over which said portable device communicates.

7. The method of claim 1, wherein said data trigger comprises a user-initiated event associated with at least one of said portable device and an application running on said portable device.

8. The method of claim 7, wherein a user-initiated event associated with said portable device is selected from a group consisting of a voice communication and a data communication using said portable device.

9. The method of claim 1, wherein said data trigger comprises a change in said attribute over time.

10. The method of claim 1, wherein said interaction is selected from a group consisting of an audio interaction and a visual interaction with said user.

11. The method of claim 1, wherein said interaction comprises a tactile interaction with said user.

12. The method of claim 1, wherein said interaction comprises delivery of at least one of a survey, advertisement, coupon and message to said user.

13. The method of claim 1 further comprising:
accessing additional data associated with said at least one attribute of said monitored data; and
interacting with said user using said additional data.

14. A computer-implemented method of interacting with users of portable devices, said method comprising:
monitoring data on a portable device;
detecting a plurality of data triggers within said monitored data using at least one component of said portable device; and
initiating an interaction with a user of said portable device in response to said detecting of said plurality of data triggers, wherein said interaction is associated with at least one attribute of said monitored data.

15. The method of claim 14, wherein said monitored data comprises a plurality of data types, and wherein each of said plurality of data types comprise at least one respective data trigger.

16. The method of claim 14, wherein said plurality of data triggers occur sequentially.

17. The method of claim 14, wherein said plurality of data triggers occur in parallel.

18. The method of claim 14, wherein said portable device is selected from a group consisting of a mobile telephone, a gaming device, and a media device.

19. The method of claim 14, wherein said plurality of data triggers is selected from a group consisting of a time of day and a location of said portable device.

20. The method of claim 14, wherein said data trigger is selected from a group consisting of a characteristic of said portable device, a characteristic of a wireless network over which said portable device communicates, and a user-initiated event associated with at least one of said portable device and an application running on said portable device.

21. The method of claim 14, wherein said data trigger comprises a change in said attribute over time.

22. The method of claim 14, wherein said interaction is selected from a group consisting of an audio interaction and a visual interaction with said user.

23. The method of claim 14, wherein said interaction comprises a tactile interaction with said user.

24. The method of claim 14, wherein said interaction comprises delivery of at least one of a survey, advertisement, coupon and message to said user.

25. The method of claim 14 further comprising:
accessing additional data associated with said at least one attribute of said monitored data; and
interacting with said user using said additional data.

26. A system for interacting with users, said system comprising:
a first component for monitoring data on a portable device and for detecting a data trigger within said monitored data; and
a second component coupled to said first component and for initiating an interaction with a user of said portable device in response to said detecting of said data trigger by said first component, wherein said interaction is associated with at least one attribute of said monitored data.

27. The system of claim 26 further comprising:
a processor coupled to said first and second components, said processor for receiving a trigger signal from said first component and generating an output signal based upon said received trigger signal; and
wherein said output signal is fed to said second component for initiating a corresponding interaction with said user.

28. The system of claim 27, wherein said trigger signal is selected from a group consisting of a signal indicating a detected trigger, a data attribute type signal associated with said data trigger, and a data attribute value signal associated with said data trigger.

29. The system of claim 26, wherein said first and second components are components of at least one of a mobile telephone, a gaming device, and a media device.

30. The system of claim 26, wherein said monitored data is selected from a group consisting of a time of day, a location of said portable device, a characteristic of said portable device, a characteristic of a wireless network over which said portable device communicates, and a user-initiated event associated with at least one of said portable device and an application running on said portable device.

31. The system of claim 26, wherein said data trigger comprises a change in said attribute over time.

32. The system of claim 26, wherein said interaction is selected from a group consisting of an audio interaction and a visual interaction with said user.

33. The system of claim 26, wherein said interaction comprises a tactile interaction with said user.

34. The system of claim 26, wherein said interaction comprises delivery of at least one of a survey, advertisement, coupon and message to said user.
